(19) United States
(12) Patent Application Publication
(10) Pub. No.: US 2013/0204570 A1
(43) Pub. Date: Aug. 8, 2013

(54) CELLULAR TELEPHONE AND CAMERA THERMOMETERS

(71) Applicants: Tzila Mendelson, Givat Shmuel (IL); Martin Sheldon Frankel, austin, TX (US)

(72) Inventors: Tzila Mendelson, Givat Shmuel (IL); Martin Sheldon Frankel, austin, TX (US)

(21) Appl. No.: 13/418,718

(22) Filed: Mar. 13, 2012

Related U.S. Application Data
(60) Provisional application No. 61/633,066, filed on Feb. 6, 2012.

(51) Int. Cl. G06F 15/00

(52) U.S. Cl. 702/135

(57) ABSTRACT

Systems and methods for sensing temperatures of objects using mobile devices and more particularly for sensing the temperature of children using smart cellular telephones and/or cameras with infrared thermal sensors. The sensed temperatures can be output via user interfaces of the mobile devices. However, this abstract is submitted with the understanding that it will not be used to limit the claims.

### CROSS REFERENCE TO RELATED APPLICATIONS

This application claims priority to U.S. Patent Application No. 61/633,066, filed on Feb. 6, 2012, by Frankel et al., titled Smart Phone Thermometer, and which is incorporated herein as if set forth in full.

### BACKGROUND

Needs for measuring the temperature of objects often arise at unexpected, inconvenient, and/or awkward times. For instance, a child may suddenly complain of feeling sick, nauseous, “not well,” “bad,” etc. At such times, a thermometer might not be readily accessible or available at all. Many of these situations occur in public places where the parent, guardian, or other person (or the child for that matter) might have only a limited collection of personal belongings on them. Other such situations occur in automobiles where the collection of available personal items is somewhat larger although still limited and usually does not include a thermometer.

As a result, persons seeking to ascertain the health of the child (or others) must resort to rather rudimentary was to judge the child's well being (or lack thereof). For instance, a fever can sometimes be sensed by feeling the child's forehead. A flushed or sweating face often indicates that the child (or individual) is suffering from a fever. Of course, various individuals can (in the alternative) suffer from unusually low temperatures. Hypothermia victims sometimes appear pale, white, “blue,” etc. at least as compared to their appearance before the onset of such conditions. All of these rudimentary methods of determining a person's temperature, though, suffer from being subjective, being affected by circumstances (for instance, the person ordinarily appears pale), and other sources of inaccuracy and/or outright error.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for sensing temperatures of objects and more particularly for sensing the temperature of children and/or other individuals using cellular telephones with built-in infrared thermal sensors.

Embodiments provide cellular telephones and cameras which can take the temperature of various objects, subjects, etc. Cellular telephones and cameras of the current embodiment are generally handy and accessible with just the reach of a hand. Moreover, these cellular telephones are usually available in most locations even those locations where, ordinarily, people would not bring a thermometer. Cellular telephones of some embodiments are operated by users (adults, young people, etc.) with one click of a button or other control action(s). Additionally, or in the alternative, the sensed temperature can be presented on a lighted display of the cell phone and/or can a lighted portion of a display. Thus, users can view the sensed temperature even in dark or dimly lit environments whereas many heretofore-available thermometers can be read (if at all) in such environments only with difficulty. Also, being non-contacted devices, cellular telephones of the current embodiment need not be sterilized even after having been used to take a temperature.

Furthermore, embodiments provide infrared temperature sensors which are practicable for a wide variety of uses. They can, for instance, be used to check the temperature of a baby, its bottle, its bath, etc. Such temperature sensors can be used to take the temperature of children (or infants) asleep in darkened rooms without touching them, turning on the lights, fear of wakening them, etc. Indeed, children (and/or others) who might find having their temperature taken unpleasant, and hence resist, might not even be aware that their temperature is being taken with such temperature sensors.

Temperature sensors of various embodiments can take temperatures in a non-intrusive manner and without exposing the user (or subject) to invasions of privacy. For instance, women wishing to time their fertility might need to take their temperatures at inconvenient times such as during the workday. With temperature sensors of the current embodiment, such women can do so without overtly revealing what they are doing (and the often intimate issues involved). However, not all uses of such temperature sensors need be biological in nature. Indeed, some uses of temperature sensors of the current embodiment are industrial and/or technical in nature such as checking the temperature of an engine, oil draining from the engine, etc.

Some embodiments provide smart cellular telephones which include a memory, a display, a processor, a camera, and an infrared thermal sensor in communication with one another. The camera of such cellular telephones defines an aperture(s) positioned to allow a line of sight of the camera to pass there through. Moreover, the aperture is positioned so that a line of sight of the infrared sensor also passes through it in parallel with the line of sight of the camera. The infrared sensors of the current embodiment are optimized to sense temperatures between approximately 95 degrees and 107 degrees Fahrenheit. The memory stores computer readable instructions which cause the processor to sense a temperature of an object via the infrared sensor and capture an image of the object via the camera. Furthermore, the instructions cause the processor to display the temperature on the display, to compare it with 98.6 degrees Fahrenheit, and to display the captured image of the object along with the temperature.

Various embodiments provide cellular telephones which include a memory storing processor executable instructions which cause the processor to sense the temperature of an object via an infrared thermal sensor and output an indication of the sensed temperature via a user interface. In some situations the indication of the temperature can be output via a speaker and/or via a display.

Implementations provide various processes for sensing the temperature of subjects using cellular telephones. Some of these processes include (among other activities) sensing the temperature of an object using an infrared temperature sensor of a cellular telephone. Other activities of such processes include processing the sensed temperature using a circuit of the cellular telephone and outputting an indication of the sensed temperature via a user interface of the cellular telephone. In some embodiments, the outputting of the temperature also includes outputting an alert if the sensed temperature is below a particular threshold and/or outputting an alert if the sensed temperature is above another particular threshold.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates a perspective view of a system for sensing an object's temperature.

FIG. 2 illustrates a block diagram of another system for sensing an object's temperature.

FIG. 3 illustrates a cross sectional view of a cellular telephone.

FIG. 4 illustrates a flow diagram of a process for sensing an object's temperature.

### DETAILED DESCRIPTION

This document discloses systems, apparatus, methods, etc. for sensing the temperature of objects and, more specifically, sensing the temperature of children and/or other individuals using smart cellular telephones with infrared thermal sensors.

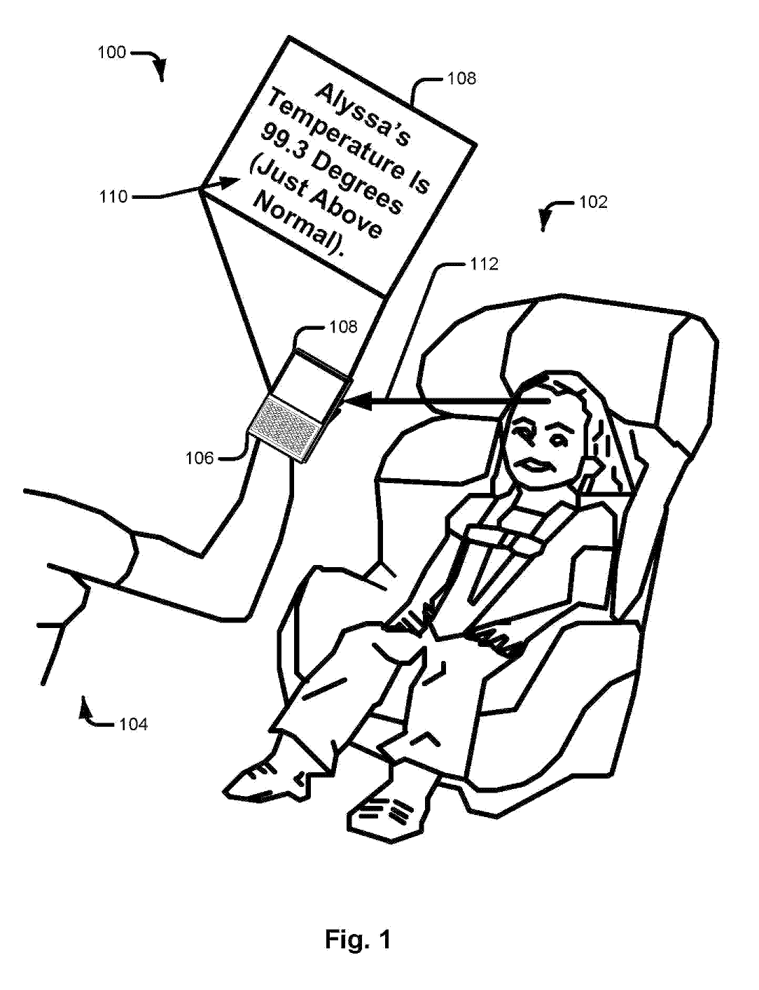

FIG. 1 illustrates a perspective view of a system for sensing an object's temperature. In the situation illustrated by FIG. 1, the system 100 is sensing the temperature of a subject 102. More specifically, a user 104 is holding a mobile device 106 which incorporates an infrared thermometer. The mobile device 106 also includes a display 108 which presents various messages 110 to the user 104. In order to take the temperature of the subject 102, the user 104 aims the mobile device 106 (or its infrared thermometer) at the subject 102 and allows the IR (infrared) thermometer to sense IR radiation 112 being generated by the subject 102. The mobile device 106 processes the sensed IR radiation 112 and displays a message 110 on the display 108 conveying the temperature of the subject 102.

While FIG. 1 illustrates a child as the subject 102, the subject 102 could be any type of person, an animal, a plant, or some other object. For instance, the subject 102 could be an automobile steering wheel or seat, a stretch of sand, a body of water (for instance, a swimming pool, lake, pond, stream, etc.), or any other object for which the user 104 desires to know its temperature. Moreover, the mobile device 106 could be any of a number of devices. For instance, the mobile device 106 of many embodiments is a cellular telephone, smart phone, iPhone®, Blackberry®, personal digital assistant, tablet computer, a camera, etc. Such mobile devices 108 are often used to communicate data, voice (audio), and/or video information to/from the user 104. Thus, users 104 tend to keep such mobile devices 108 with them much of the time. The displays 108 of such mobile devices 108 might have the capability to display graphical user interfaces (GUIs), just text-based messages 110, a mixture thereof, etc.

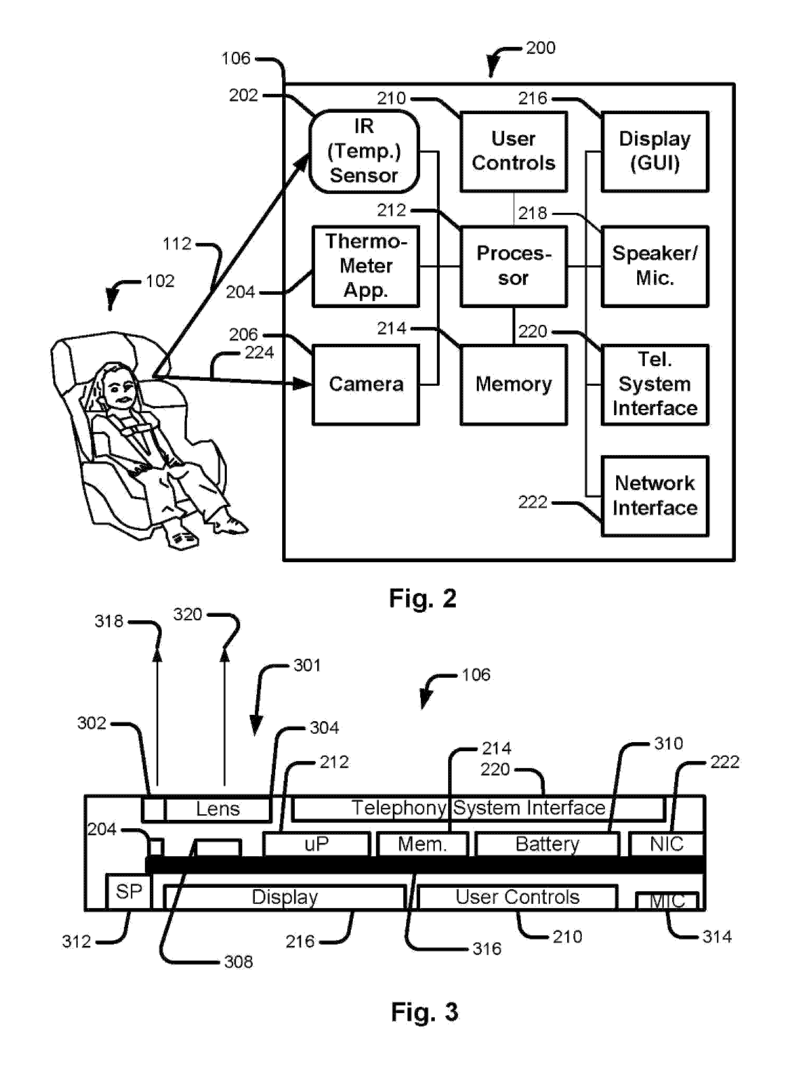

FIG. 2 illustrates a block diagram of another system for sensing an object's temperature. The system 200 can be housed within a mobile device 106 and can include a mixture of hardware, firmware, software, etc. For instance, the mobile device 106 can include an IR (or scanning) sensor 202, a thermometer application 204, a camera 206, some user controls 210, a processor 212, a memory 214, a display 216, a speaker/microphone 218, a telephony system interface 220, a network interface 222, etc. FIG. 2 also shows the IR radiation 112 and visible radiation 224 (i.e. “light”) emanating and/or being reflected from the subject 102 or some other object.

The IR sensor 202 can be any type of device capable of producing an output signal in response to IR radiation 112. More specifically, that output signal can depend on the frequency (or wavelength) of the sensed IR radiation 112 or could even be at least somewhat proportional thereto. Thus, the IR sensor 202 can sense the temperature of the subject 102 via the IR radiation 112 it receives from the subject 102. Many embodiments provide mobile devices 106 with cooled and/or un-cooled IR sensors 202 based on technologies such as those associated with IR sensors fabricated from vanadium oxide, lanthanum barium manganite, amorphous silicon, lead zirconate titanate, lanthanum doped lead zirconate titanate, lead scandium tantalite, lead lanthanum titanate, lead titanate, lead zinc niobate, lead strontium titanate, barium strontium titanate, barium titanate, antimony sulfoiodide, polyvinylidene difluoride, etc. However, IR sensors 202 based on other technologies can be employed. In some embodiments, the IR sensor 202 and/or supporting electronics, optics, etc. can be configured to sense temperatures between about 95 degrees Fahrenheit and about 107 degrees Fahrenheit or other temperature ranges.

The thermometer application 204 can be configured to accept the output signal of the IR sensor 202 and convert it to a temperature on a selected scale such as the Fahrenheit, Celsius, Centigrade, Kelvin, etc. scales for presentation on the display 216. Thus, IR sensors 202 of some embodiments can be aimed generally at an object, receive IR radiation emanating there from, and convert the frequency thereof to an electrical voltage or current which can be sensed by various electronic components (or software/firmware operating in conjunction therewith). Moreover, in some embodiments, the thermometer application 204 can be installed on the mobile device 106 as part of its assembly, configuration, etc. However, the thermometer application 204 can also be installed thereon at some other time. For instance, the thermometer application 204 could be purchased online (or otherwise) and/or separately from the mobile device 106 and installed at a time selected by the user.

FIG. 2 also illustrates that the system 200 of the current embodiment includes a camera 206 positioned in the mobile device 106 to receive the visible radiation 224 from the subject 102. The camera 206 can be in communication with the processor 212. As a result, the mobile device 106 can take photographs, videos, and/or otherwise capture images of the subject 102. Indeed, in some embodiments, the thermometer application 204 can cause the camera 206 to capture an image of the subject 102 at about the same time that the IR sensor 202 takes a temperature of the subject 102. The processor 212 can cause that captured image and that temperature reading to appear on the display 216 at about the same time.

Moreover, the camera 206 could be a charge coupled device (CCD) or be based on some other technology. In some embodiments, for instance, the camera 206 is based on CMOS technology. The scope of the disclosure, furthermore, includes cameras 206 which include the IR sensor 202 or vice versa. In the alternative, or in addition, mobile devices 106 of various embodiments include IR sensors 202 and cameras 206 which are packaged together and held in registration with one another. Mobile devices 106 of such embodiments may also include lenses, filters, and/or other optical devices to focus radiation (albeit infrared or visible radiation) on devices associated with the camera 206 and IR sensor 202 and/or otherwise support the same.

The system 200 of the current embodiment also includes user controls 210 to allow the user 104 to manipulate the mobile device 106 and/or to control the operations of the IR sensor 202, the thermometer application 204, and/or the camera 206. For instance, by pressing some hardwired switch, “soft” button, graphical icon, or other user controls 210 the user 104 can activate the thermometer application 204. User manipulation of another (or the same) user control 210 can cause the camera 206 to capture an image and can cause the IR sensor 202 to take a temperature reading.

Processors 212 of some embodiments can execute processor readable instructions which cause the processor 212 to perform various processes such as operating various portions of the mobile device 106. For instance, the processor could execute the thermometer application 204 and/or applications associated with the camera 206, the user controls 210, the display 216, the speaker/microphone 218, the telephony system interface 220, the network interface 222, etc. The processor 21 of certain embodiments can be any type of processor capable of executing such instructions. For instance, the processor 212 could be a microprocessor, an application specific integrated circuit (ASIC), a reduced instruction set computer (RISC), etc.

With continuing reference to FIG. 2 the memory 214 can store processor executable instructions for operating the system 200. The memory 214 can also store the images captured by the camera 206 and the temperature readings taken by the IR sensor 202. The display 216, of some embodiments, presents those images and temperatures readings. It can also present certain “soft” user controls 210 for the user 104 to use in controlling the mobile device 106. For instance, the display 216 and/or other user controls 210 can allow the user 104 to input notes, observations, information, and/or otherwise annotate the captured images and temperature readings as desired.

As FIG. 2 illustrates, the telephony system interface 220 (which includes a transmitter, antenna, etc.) can allow the user 104 to use the mobile device as a cellular or other type of telephone. In some cases, the telephony interface 220, in cooperation with the thermometer application 204 can transmit the temperature readings and (if desired) other information to recipients with telephone numbers, fax numbers, etc. The telephony system interface 220 can operate in accordance with one or more of a variety of telephony protocols/standards. For instance, the telephony system interface 220 could be configured in accordance with global system for mobile communication (GSM) protocol, code division multiple access (CDMA) protocol, etc. The network interface 222 can perform similar functions but with respect to a local area network (LAN), wide area network (WAN), or other network such as the Interface. As such, the network interface 222 could support transfer control protocol/internet protocol (TCP/IP), universal serial bus (USB), Ethernet, etc. protocols.

FIG. 3 illustrates a cross sectional view of a cellular telephone. More specifically, FIG. 3 schematically shows how a mobile device 106 of some embodiments integrates an IR sensor 202 into the mobile device 106. Thus, FIG. 3 shows an aperture 301, an IR port 302 or other sensor face, a lens 304, and an image sensor 308 or other photo detector. In the current embodiment, the mobile device 106 also includes a battery 310, a speaker 312, and a microphone 314. Many of the components 202, 212, 214, 222, 308, and 310 can be connect by, and mounted on, a printed circuit board (PCB) 316 while other components 210, 216, 220, and 314 can be connected to each other via wiring, ribbon cables, etc. Although such arrangements do not limit the scope of the disclosure.

With continuing reference to FIG. 3, the IR sensor 202 can be positioned behind and held in fixed relationship with the IR port 302. In some embodiments, the IR port 302 can be transparent to IR radiation 112. Of course, the IR port 302 can have optical properties selected to allow a particular band(s) of IR radiation 112 to pass there through. Accordingly, the IR port 302 can act as an IR filter if desired. In addition, or in the alternative, the IR port 302 (or other components) can focus the IR radiation 112 on to the IR sensor 202. In other words, the IR sensor 202 can be positioned relative to the IR port 302 such that its line of sight 318 looks out of the mobile device 106 through the IR port 302.

Likewise, the image sensor 308 can be positioned relative to the lens 304 so that the lens 304 focuses visible radiation on the image sensor 308 (and/or filters out selected bands of visible radiation 224). Thus, the line of sight 320 of the image sensor 308 can look out of the mobile device 106 through the lens 304. Moreover, the PCB 316 and/or other structures of the mobile device 106 can hold the IR sensor 202, the IR port 302, the lens 304, and the image sensor 308 in registration with one another such that the IR sensor line of sight 318 and the image sensor line of sight 320 are approximately parallel to each other. Accordingly, the image sensor 308 can capture an image of the same subject 102 for which the IR sensor 202 has taken the temperature. Of course, in some embodiments, the IR sensor 202 and the image sensor 308 have their own apertures 301.

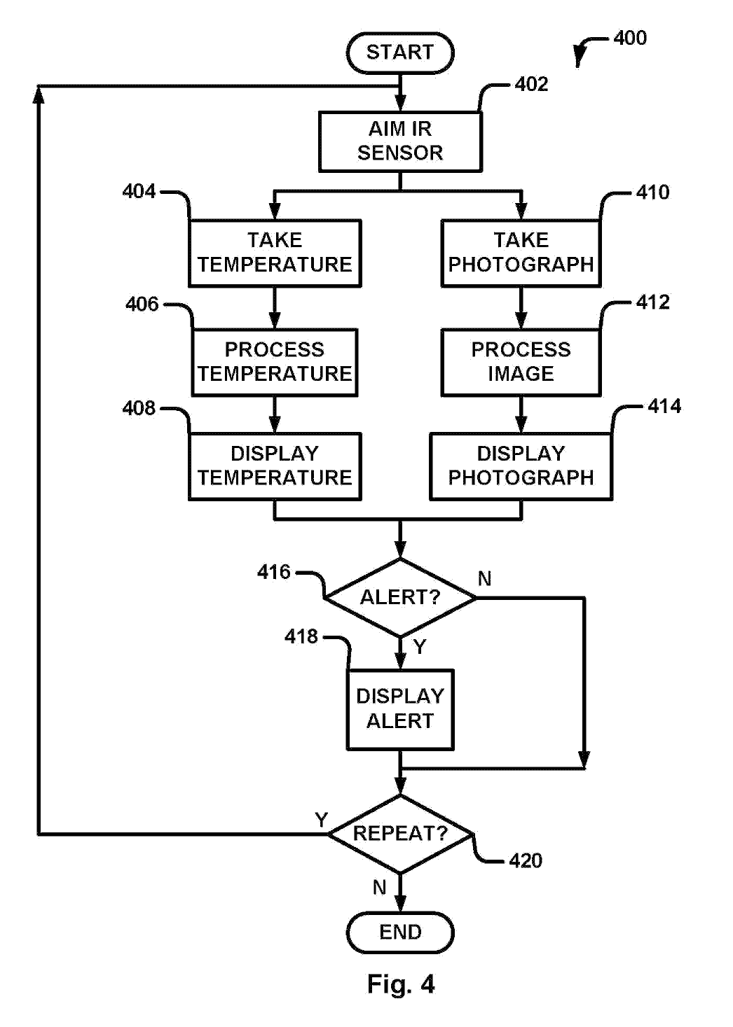

FIG. 4 illustrates a flow diagram of a process for sensing an object's temperature. More specifically, the process 400 can begin with the user 104 becoming interested in taking the temperature of the subject 102. For instance, a mother might sense that her child is not feeling well. Since it might be the case that the user 104 has a mobile device 106 handy, the user 104 might aim the IR sensor 202 in the mobile device 106 at the subject 102. See reference 402.

The user can then manipulate the user controls 210 of the mobile device 106 to trigger the thermometer application 204 to take a temperature reading of the subject 102. See reference 404. The thermometer application 204 can process the output of the IR sensor 202 to convert it to some selected scale as indicated by reference 406. If desired, at reference 408 or at other times, the thermometer application 204 can display that temperature reading (as converted) on the display 216.

In some implementations, the processor 212 can be configured to also capture an image of the subject 102 as the temperature reading is being taken. Thus, process 400 can include taking a photograph of the subject 102 as illustrated at reference 410. The captured image can be processed by the processor 212 or some other entity and displayed on display 216. See references 412 and 414 respectively.

With continuing reference to FIG. 4, process 400 of some implementations also displays an alert on display 216 in response to some circumstances. For instance, if the sensed temperature happens to be above (or below) a selected threshold, the thermometer application 204 can cause an alert to displayed on display 216 indicating the corresponding condition. See reference 416. For instance, if the thermometer application 204 is configured to sense the body temperature of human subjects 102, then it can output an alert if the body temperature exceeds 98.6 degrees Fahrenheit by some amount. In other words, if the human subject 102 has a fever, the display 216 can indicate that condition. If, on the other hand, the human subject 102 is suffering from some degree of hypothermia, the display can so indicate. See reference 418. Furthermore, process 400 can continue in whole or in part as indicated at reference 420.

Various embodiments and implementations provide systems, apparatus, processes, etc. for taking temperatures of various objects, subjects, etc. Many of these embodiments and implementations involve the use of mobile devices such as cellular telephones. Since such mobile devices are available with increasing frequency and can be carried on the bodies of various users, embodiments provide convenient means for taking such temperatures at many times, in many places, and/or under many circumstances without requiring users to carry separate thermometers with them.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. An apparatus comprising:
a smart cellular telephone further comprising:
a memory;
a processor in communication with the memory;
a display in communication with the processor;
a camera defining a first line of sight, the cellular telephone defining an aperture positioned to allow the first line of sight of the camera to pass there through; and
an infrared thermal sensor defining a second line of sight and being in communication with the processor, the infrared thermal sensor being positioned such that the second line of sight of the infrared thermal sensor passes through the aperture in parallel with the first line of sight of the camera, the infrared thermal sensor being optimized to sense temperatures within a range of about 95 degrees Fahrenheit to about 107 degrees Fahrenheit;
the memory storing a smart phone application further comprising processor executable instructions which when executed by the processor cause the processor to execute a process further comprising:
sensing a temperature of an object spaced apart from the cellular telephone via the infrared thermal sensor,
capturing an image of the object spaced apart from the cellular telephone via the camera, and
displaying the image of the object captured by the camera and graphically displaying an indication of the temperature on the display in degrees Fahrenheit as compared to 98.6 degrees Fahrenheit.

2. A camera comprising:
a memory;
a processor in communication with the memory;
a user interface in communication with the processor; and
an infrared thermal sensor in communication with the processor;
the memory to store processor executable instructions which when executed by the processor cause the processor to execute a process further comprising:
sensing a temperature of an object separate from the camera via the infrared thermal sensor,
outputting an indication of the sensed temperature via the user interface.

3. The camera of claim 2 wherein the camera is a portion of a cellular telephone.

4. The camera of claim 2 wherein the user interface further comprises a display and the outputting of the indication of the temperature is via the display.

5. The camera of claim 2 further comprising a lens defining a first line of sight, the camera defining an aperture positioned to allow the first line of sight of the lens to pass there through.

6. The camera of claim 5 wherein the infrared thermal sensor defines a second line of sight and is positioned such that the second line of sight of the infrared thermal sensor passes through the aperture.

7. The camera of claim 6 wherein the second line of sight of the infrared thermal sensor is parallel to the first line of sight of the lens.

8. The camera of claim 7 wherein the instructions further cause the processer to display an image of the object captured by the camera.

9. The camera of claim 2 wherein the instructions further cause the processor to graphically display the indication of the temperature on the display in degrees Fahrenheit as compared to 98.6 degrees Fahrenheit.

10. The camera of claim 2 wherein the infrared thermal sensor is configured to sense temperatures within a range of about 95 degrees Fahrenheit and about 107 degrees Fahrenheit.

11. A process for sensing the temperatures of objects using a cellular telephone, the process comprising:
sensing a temperature of an object using an infrared temperature sensor of a cellular telephone, the object being spaced apart from the cellular telephone;
processing the sensed temperature using a circuit of the cellular telephone to determine the sensed temperature; and
outputting an indication of the temperature of the object sensed by the infrared temperature sensor via a user interface of the cellular telephone.

12. The process of claim 11 wherein the user interface further comprises a speaker and the outputting of the indication of the temperature is via the speaker.

13. The process of claim 11 wherein the user interface further comprises a display and the outputting of the indication of the temperature is via the display.

14. The process of claim 11 wherein the cellular telephone further comprises a camera defining a first line of sight, the cellular telephone defining an aperture positioned to allow the first line of sight of the camera to pass there through.

15. The process of claim 14 wherein the infrared thermal sensor defines a second line of sight and is positioned such that the second line of sight of the infrared thermal sensor passes through the aperture.

16. The process of claim 15 wherein the second line of sight of the infrared thermal sensor is parallel to the first line of sight of the camera.

17. The process of claim 14 further comprising displaying an image of the object captured by the camera.

18. The process of claim 11 further comprising graphically displaying an indication of the temperature on the display in degrees Fahrenheit as compared to 98.6 degrees Fahrenheit.

19. The process of claim 11 wherein the infrared thermal sensor is optimized to sense temperatures within a range of about 95 degrees Fahrenheit and about 107 degrees Fahrenheit.

20. The process of claim 11 wherein the outputting of the indication of the temperature of the object further comprises outputting an alert if the temperate of the object is above a first threshold or below a second threshold.
